(19) United States
(12) Patent Application Publication
(10) Pub. No.: US 2026/0048557 A1
(43) Pub. Date: Feb. 19, 2026

(54) MULTILAYER CONTINUOUS FIBER FILAMENT WITH A DUALLY REACTIVE MATRIX AND METHOD FOR MANUFACTURING THEREOF

(71) Applicant: LUXEMBOURG INSTITUTE OF SCIENCE AND TECHNOLOGY (LIST), Esch-sur-Alzette (LU)

(72) Inventors: Vincent BERTHE, Esch-sur-Alzette (LU); Henri PERRIN, Esch-sur-Alzette (LU)

(21) Appl. No.: 19/101,324

(22) PCT Filed: Aug. 4, 2023
(86) PCT No.: PCT/EP2023/071706

§ 371 Date: Feb. 5, 2025

(30) Foreign Application Priority Data
Aug. 5, 2022 (LU) LU502631

(51) Int. Cl. B29C 70/00; B29B 11/16; B29C 70/32; B29K 33/00; B29K 105/10; B29K 307/04; B33Y 70/10

(52) U.S. Cl. CPC B29C 70/003; B33Y 70/10; B29B 11/16; B29C 70/32; B29K 2033/12; B29K 2105/106; B29K 2307/04

(57) ABSTRACT

A filament for an additive manufacturing application or a winding application. The filament including fibers embedded in a reactive matrix including a reactive blend of: a reactive thermoplastic matrix with a glycidyl methacrylate monomer and/or with a methacrylic acid monomer. The filament further including a sheath layer wrapping the matrix, the sheath layer being made of a thermoplastic material. A use of the filament for manufacturing an end product by an additive manufacturing process or by a winding technique. A method for manufacturing such a filament.

### TECHNICAL FIELD

The invention relates to the field of composite materials that can be used in additive manufacturing or in winding applications, more specifically, the invention relates to continuous fiber reinforced thermoplastic composites (CFRTPC) suitable for fuse filament fabrication (FFF).

In particular, the invention relates to composite materials used for the manufacturing of parts and structures, such as lightweight structures used in automotive, aircraft or space industry.

### BACKGROUND ART

Composite filaments used for fused filament fabrication and winding applications are made from a thread or a roving of fibers, especially carbon fibers, and are known from prior art under the name of continuous fiber reinforced filaments or prepregs.

In fact, composite filaments are commonly used to form 3D-printed parts by additive manufacturing processes wherein the part is formed from successive layers created by melting the filament. On the other hand, composite filaments can also have the form of a tape especially when used in a winding process, also called weaving process. In a winding process, a composite structure is formed.

It is known from the state of the art that the roving is impregnated using a binder. For instance, a thermosetting binder based on a thermoset resin is commonly used to impregnate the thread of carbon fibers.

However, the thermoset resin presents considerable material formability limitations, especially when heated, inducing cracks during the printing operation (or insufficient flexibility).

In fact, the impregnating binder of the composite filament needs to be fully cured before the filament can be used in an additive manufacturing process. For that purpose, it is known from the art to use an oven configured to heat the thermoset resin to temperatures rising up to 400° C. However, in order to fully cure the thermoset binder, around 10 min of total curing time are usually necessary. Since the process duration is dependent on the curing time, the slow curing process results in a slow filament production rate, typically having a speed ranging from 0.3 m/min to 1 m/min. Added to that, a technical analysis has been carried out which supports that this method of curing a thermoset resin induces high number of voids and an uneven filament section.

Another disadvantage of using a thermoset resin-based binder for impregnating the composite filament, is the limited physicochemical compatibility between the filament and other thermoplastic materials used in a later stage of the forming process, i.e., 3D printing or overmolding. This insufficient compatibility results in a poor filament morphological quality during the additive manufacturing process and the 3D-printed part using that filament usually demonstrates mechanical properties which may not be seen as sufficient for every application.

In fact, a weak adhesion between the thermoset-based continuous fiber filament and the thermoplastic polymer is observed during the 3D printing process. A relative motion (sliding) of the filament with respect to the resin can even be observed. This impacts negatively the mechanical resistance of the final product and its longevity (low ageing resistance).

The document WO 2017/188861 A1 discloses an example of such known techniques. A prepreg which is considered as a commodity polymer is produced by the impregnation of fibers using a full bath of liquid thermoset resin followed by curing using an oven. The production rate of the composite filament depends on curing time, which constitutes an intrinsic technological limit of productivity.

The filament disclosed in the document WO 2017/188861 A1 also presents limits of material formability and a limited production rate due to the curing time of the epoxy matrix. In fact, the filament is generated at a speed of around 1 m/min which leaves some margin for improvement. In addition, the question of compatibility during the additive manufacturing process discussed above in the case of multi-material assembly is not solved.

### SUMMARY OF INVENTION

### Technical Problem

The present invention addresses the above-mentioned deficiencies and aims at providing a composite filament with a superior hot formability, a better flexural strength and an improved compatibility and adhesion with a large range of technical polymers during additive manufacturing for facilitating and enhancing the 3D-printing or winding processes.

The invention further aims at providing a manufacturing method for the filament enabling to manufacture products of higher quality, leading to increased properties and ageing resistance.

### Solution

The above-stated problem is solved by a filament for an additive manufacturing application or a winding application, the filament comprising fibers embedded in a reactive resin matrix comprising a reactive blend of: a reactive thermoplastic resin with a glycidyl methacrylate monomer and/or with a methacrylic acid monomer, said filament further comprising a sheath layer wrapping the resin matrix, the sheath layer being made of a thermoplastic material.

Glycidyl methacrylate or methacrylic acid is a functional monomer blended with the reactive thermoplastic matrix. This blend advantageously provides the filament of the invention with a strong adhesion between the reactive matrix and the sheath layer, resulting in an overall better formability and an enhanced homogeneity of the filament, resulting in an end product of higher mechanical strength.

According to a preferred embodiment, the reactive thermoplastic matrix is mainly composed of (meth)acrylic polymer, (meth)acrylic monomer and organic peroxides.

According to a preferred embodiment, the reactive matrix comprises the glycidyl methacrylate monomer and/or the methacrylic acid monomer, in an amount of 0.1 to 10 wt % of said matrix.

According to a preferred embodiment, the weight ratio of the glycidyl methacrylate monomer and/or the methacrylic acid monomer particles to the reactive thermoplastic matrix particles is 0.001:1 to 0.1:1.

According to a preferred embodiment, the reactive matrix is a co-polymer comprising poly(methyl methacrylate-co-glycidyl methacrylate). Advantageously, the co-polymer structure obtained is the same regardless of the content of glycidyl methacrylate.

According to a preferred embodiment, the reactive matrix is a co-polymer comprising poly(methyl methacrylate-co-methacrylic acid). Advantageously, the co-polymer structure obtained is the same regardless of the content of methacrylic acid.

According to a preferred embodiment, the thermoplastic material of the sheath layer comprises polyamide, said polyamide being polyamide 6 or polyamide 12 or polyamide 66 or a mixture thereof, said polyamide forming at least 90 wt % of the sheath layer.

The invention also relates to a use of the filament of any of the above-mentioned embodiments for manufacturing an end product by an additive manufacturing process or by a winding technique, and preferably a 3D-printing process.

According to a preferred embodiment, prior to a deposition of the filament to form the end product, the reactive matrix is wrapped in by the sheath layer.

The invention also relates to a product obtained by the use of the filament in accordance with any of the preceding paragraphs regarding the use of the filament. As explained further in details below, a product obtained with the filament of the invention is structurally distinct from a product obtained otherwise. In this regard, pull-off tests can further support the distinction.

Advantageously, the formability and the homogeneity of the end product is enhanced, making it possible for said end product to be used for physically more demanding industrial utilizations such as lightweight structures used in automotive, aircraft or space industry.

The invention also relates to a method for manufacturing a filament aimed to an additive manufacturing application or a winding application, the method comprising: providing a thread of fibers; impregnating the thread with a reactive resin matrix comprising a reactive blend of: a liquid reactive thermoplastic matrix and a glycidyl methacrylate monomer and/or with a methacrylic acid monomer; and co-extruding a sheath layer of thermoplastic material around the impregnated thread.

Preferably, the thread impregnation is done by pultrusion.

According to a preferred embodiment, prior to impregnating the thread, the method comprises: blending the glycidyl methacrylate monomer and/or the methacrylic acid monomer in a content of 0.1 to 10 wt % of an entire amount of the matrix, with the liquid reactive thermoplastic matrix being mainly composed of (meth)acrylic polymer, (meth)acrylic monomer and organic peroxides.

Advantageously, the glycidyl methacrylate monomer of the continuous fiber composite matrix layer chemically interacts with the polyamide contained in the co-extruded sheath layer, therefore allowing an enhanced adhesion between those two layers (reactive matrix and the sheath layer), said adhesion comprehensively enabling improvements of the structural properties of the filament.

The co-extrusion of the sheath layer enables to produce a filament without having to wait for the thermoplastic impregnation matrix to complete its polymerization, thereby waiving the time constraint of known methods. Also, the process of applying the sheath layer improves the circularity, and dimensional control, homogeneity and cross-section profile of the filament.

Preferably, the co-extrusion of the sheath layer is done on the blended reactive matrix while it is not yet totally cured, and this advantageously enables a combination of chemical and mechanical interlocking, ensuring higher adhesion properties for the filament.

According to a preferred embodiment, at least 90 wt % of the thermoplastic material is made of polyamide.

According to a preferred embodiment, the thermoplastic material is co-extruded at a temperature comprised in the range of 160-240° C.

Preferably, the method further comprises a polymerization step of the liquid reactive matrix right after co-extrusion of the sheath layer. Said polymerization step can be achieved using an oven which ensures polymerization at a temperature that is lower than the melting temperature of the sheath layer, the former being preferably around 100° C. while the latter is preferably around 200° C. “around” is intended to mean plus or minus 10% of the given values. This ensures that the sheath layer is not altered in shape or structure during polymerization of the matrix.

Advantageously, the chemical composition of the thermoplastic compound constituting the sheath layer enables solidification of said sheath layer at least partially before polymerization of the liquid reactive matrix. The moulding of the sheath layer can optionally overlap the polymerization of the matrix, meaning that the sheath layer can still be solidifying while the filament enters the oven. The polymerization of the matrix is controlled and a chemical reaction of the liquid reactive matrix into the sheath layer occurs, thereby creating a strong chemical and mechanical bond.

According to a preferred embodiment, the thermoplastic matrix is co-extruded at a rate of about 10 meters per minute. “about” is intended to mean plus or minus 20% of the given value. Advantageously, the composition of the liquid reactive matrix of the invention allows the impregnated thread to be sufficiently hard and only with a quick polymerization time in the oven, i.e., 3 minutes, said composition can fully cure subsequently outside the oven and at room temperature, thus enabling fast production rates.

### BRIEF DESCRIPTION OF THE DRAWINGS

FIG. 1 is a schematic representation of a method for manufacturing a composite filament according to the invention;

FIG. 2 shows a schematic representation of a co-polymer comprising poly(methyl methacrylate-co-glycidyl methacrylate), said co-polymer corresponding to a reactive matrix comprised in the filament, according to a first embodiment of the invention;

FIG. 3 shows a schematic representation of a co-polymer comprising poly(methyl methacrylate-co-methacrylic acid), said co-polymer corresponding to the reactive matrix according to a second embodiment of the invention;

FIG. 4 illustrates a flatwise tensile strength test performed on a sample composed of sandwich panels of a reactive matrix and polyamide;

FIG. 5 shows multiple SEM micrographs of the sample of FIG. 4 at different temperatures;

FIG. 6 is a representation of two cross sections of the composite filament of the invention;

FIG. 7 is an illustration of a 3D printing application of the composite filament of FIG. 6.

### DETAILED DESCRIPTION OF THE DRAWINGS

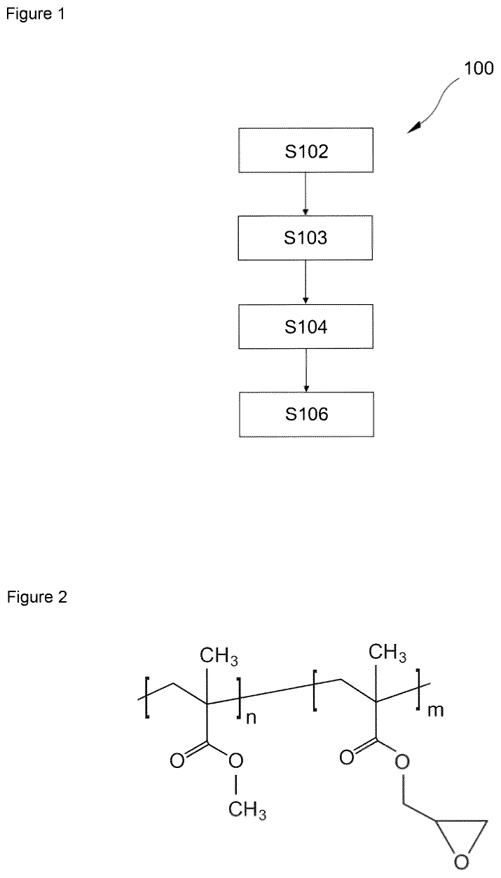

FIG. 1 is a schematic representation of a method 100 for manufacturing a composite filament aimed to an additive manufacturing application or a winding application, the method 100 comprises a plurality of steps S102, S103, S104 and S106. Said steps will be described within the established order.

A first step S102 of providing a roving or a thread of fibers for instance by unrolling a bobbin containing the thread. Fibers can be made from any of the following list: carbon, basalt, kevlar, fiberglass, or any metallic continuous fiber.

Preferably, the thread is made of dry carbon fibers, more preferably, 1K and 3K carbon fiber available from Tejin.

A step S103 which consists in blending a liquid reactive thermoplastic matrix and a monomer in order to obtain a reactive matrix in a liquid state.

The liquid reactive thermoplastic matrix is mainly composed of (meth)acrylic and (meth)acrylic monomer which together form a (meth)acrylic monomer-polymer mixture being in a liquid state.

Preferably, the liquid reactive thermoplastic matrix is Elium® C585 provided by the company Arkema.

The monomer that is blended with the liquid reactive thermoplastic correspond to a glycidyl methacrylate (GMA) or a methacrylic acid monomer (MA), or a mixture of both. In fact, each of said monomers correspond to a dual functional monomer that contains both of vinylic and epoxy functions, having a dual functionality bringing together its ability to polymerize with the liquid reactive thermoplastic matrix and then react (by step-growth polymerization) with an extremely wide range of functions such as: —COOH (acids), —NH₂ (amine), —NH—, (secondary amines or amides), —OH (hydroxyls), -maleic anhydride and then a wide range of polymers such as PA10, PA11, PA12, PA6, PA6-6, PA6-10, etc.

GMA and/or MA constitutes preferably 0.1 to 10 wt % of an entire amount of the reactive matrix, and more preferably 1 to 7 wt %.

The weight ratio of glycidyl methacrylate and/or methacrylic acid monomer particles to the reactive thermoplastic matrix particles is 0.001:1 to 0.1:1, and preferably 0.01:1 to 0.08:1.

Preferably, the liquid reactive matrix further comprises a mix of initiators, like organic peroxides which advantageously enable fast polymerization of the matrix, e.g., a polymerization duration of 3 minutes at 110° C.

Advantageously, the obtained liquid reactive matrix carries reactive functions that can react with thermoplastic overmolding layers, as described further below.

Step S104 consists in impregnating a thread of fibers with the blended reactive matrix. In fact, the impregnation is made while the thermoplastic resin is in a liquid state.

Preferably, the matrix has a dynamic viscosity of less than 1 Pa·s (Poiseuille). Furthermore, the impregnation step S104 is made at room temperature, preferably ranging from 15° C. to 35° C. Hence, the liquid matrix is at low temperature.

The method 100 further comprises a step S106 of co-extruding a sheath layer of thermoplastic compound around the impregnated thread in an uncured state. The co-extrusion can be carried out by an extruder like a single screw extruder for instance.

The thermoplastic compound of the sheath layer comprises polyamide, said polyamide being polyamide 6 or polyamide 12 or polyamide 66 or a mixture thereof.

Preferably, polyamide is forming at least 90 wt % of the sheath layer, and more preferably, polyamide is forming the entirety of the sheath layer.

Preferably, the thermoplastic compound of the sheath layer corresponds to polyamide 12, polyamide 12 will be designated by PA12 in this description, the PA12 is a Rilsamid® polyamide 12 available from Arkema.

Preferably, the co-extrusion step S106 is performed at a high temperature, e.g., about 200° C. or 220° C., which is above the melting temperature of the thermoplastic compound of the sheath layer, i.e., 200° C. or typically around 180° C.

Furthermore, and thanks to the fast-polymerization capacity of the liquid reactive matrix, the sheath layer is co-extruded at a rate of about 10 meters per minute.

Right after the co-extrusion step S106, solidification of the sheath layer can at least partially occur at room temperature. Advantageously, the solidification of the sheath layer helps containing the thermoplastic matrix impregnating the fibers even if it is still in a liquid state before polymerization of the fiber thermoplastic matrix. Said solidification also enables maintaining a circular and homogeneous shape of the filament during and following the polymerization.

FIG. 2 a schematic representation of a co-polymer comprising poly(methyl methacrylate-co-glycidyl methacrylate), said co-polymer corresponding to the reactive matrix comprised in the filament, according to a first embodiment of the invention.

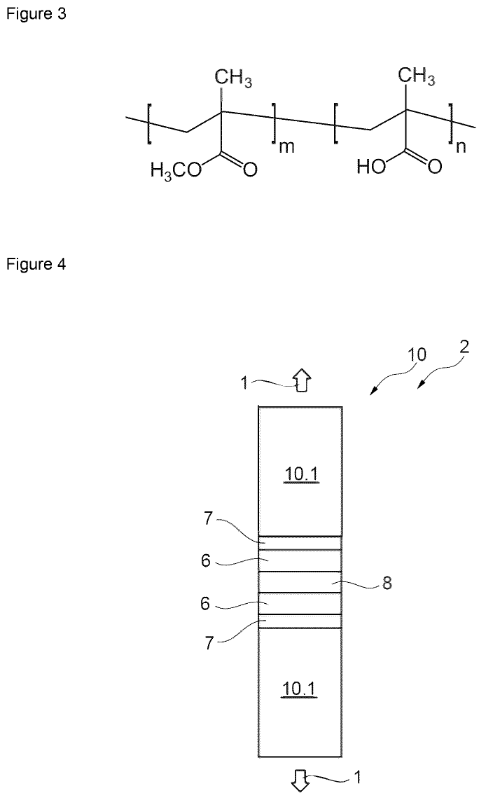

FIG. 3 shows a schematic representation of a co-polymer comprising poly(methyl methacrylate-co-methacrylic acid), said co-polymer corresponding to the reactive matrix according to a second embodiment of the invention.

In fact, the blending of the GMA or MA in an amount of 0.1-10 wt % with the liquid reactive (meth)acrylic monomer-polymer mixture in a liquid state, advantageously enables an interlocking reaction and a chemical bonding between the former and the latter.

Alternatively, a third embodiment of the invention correspond to a combination of the first and second embodiments. In this configuration, GMA and MA are blended together along with the Elium® matrix. For instance, an amount of 2.5 wt % of GMA can be blended with 2.5 wt % of MA and with 90 wt % of the Elium® matrix.

Preferably, the obtained liquid reactive matrix after the blend (according to one of the three embodiments of the invention) will enhance the interaction and the compatibility with a large range of thermoplastics, notably along temperatures that will be defined later on in this description. The compatibility will be further explained in this description, notably with measured adhesion values.

FIG. 4 illustrates a flatwise tensile strength test 2 performed on a sample 4 composed of sandwich panels of a reactive matrix 6, toughened structural methacrylate adhesive 7, and polyamide 8.

The toughened structural methacrylate adhesive panels 7 are fixed to a respective aluminum block 10.1 of a traction machine 10 exerting a pull-off force (noted with the arrows 1). The machine conforms to the standard ASTM C297. The adhesive panels 7 enable to achieve a strong fastening between the polyamide panel 8 and the block 10.1.

Preferably, the polyamide panels 6 are made of PA12, and more preferably Rilsamid® polyamide 12 available from Arkema

Preferably, the panels 7 correspond to performance polymers made from Devcon® Devweld 530 available on the market.

The panels 6, 7 and 8 of the sample 4 are preferably molded blocks of a rectangular shape.

The flatwise tensile test 2 aims at measuring the adhesion between each panel at a given temperature, in order to determine how well the panels stick to one another, therefore determining the compositions enabling the highest adhesion and compatibility.

For that matter, multiple compositions were tested at a temperature of 200° C. (corresponding to a typical 3D printing temperature), such as: glycidyl methacrylate (GMA), methacrylic acid (MA) methacrylamide, and (Trimethylsilymethyl) methacrylate.

The multiple monomer compositions were tested along different panels compositions, table 1 discloses different combinations between said monomers compositions and different thermoplastics that showed good results.

TABLE 1

| Monomers/thermoplastics | C1 | C2 | C3 | C4 | C5 |
|---|---|---|---|---|---|
| Glycidyl methacrylate | Ok | Ok | Ok | Ok | |
| Methacrylic acid | Ok | Ok | Ok | Ok | Ok |
| Methacrylamide | Ok | Ok | | Ok | Ok |
| (Trimethylsilymethyl)methacrylate | | Ok | | Ok | |

C1: Polyamides (PA6, 66, 10, 11, 12, 6-10 . . . )
C2: Polyesters (PLA, PET, PBT, . . . )
C3: Amino grafted or containing polymers
C4: Hydroxy/Acid/maleic anhydride grafted or containing polymers
C5: Epoxy grafted or containing polymer.

Glycidyl methacrylate (GMA) and methacrylic acid (MA) are the ones that showed the best adhesion results with polyamide surfaces, as it can be seen in table 2 below:

TABLE 2

| | Measured |
|---|---|
| | adhesion by |
| | pull off test on |
| | PA12 surfaces |
| Thermoplastic matrix composition | (MPa) |
| Acrylic monomer MMA (Elium ® C585) | 0 |
| Acrylic monomer MMA (Elium ® C585) + | 16 |
| 5 mol % of MA | |
| Acrylic monomer MMA (Elium ® C585) + | 18 |
| 5 mol % of GMA | |

The values in the right-hand side column (MPa) correspond to the additional pull-off forces that can be exerted by the machine (in comparison to the acrylic monomer MMA alone) before observing desolidarization of the panels.

We can see from the above table that blending MA with Elium® presents an adhesion of 16 MPa with the polyamide outer shell, and blending GMA with Elium® increases by 18 MPa said adhesion. This supports the assumption that the reactive blend and the polyamide show an enhanced compatibility that will advantageously provide the filament of the invention with an overall better strength and performance.

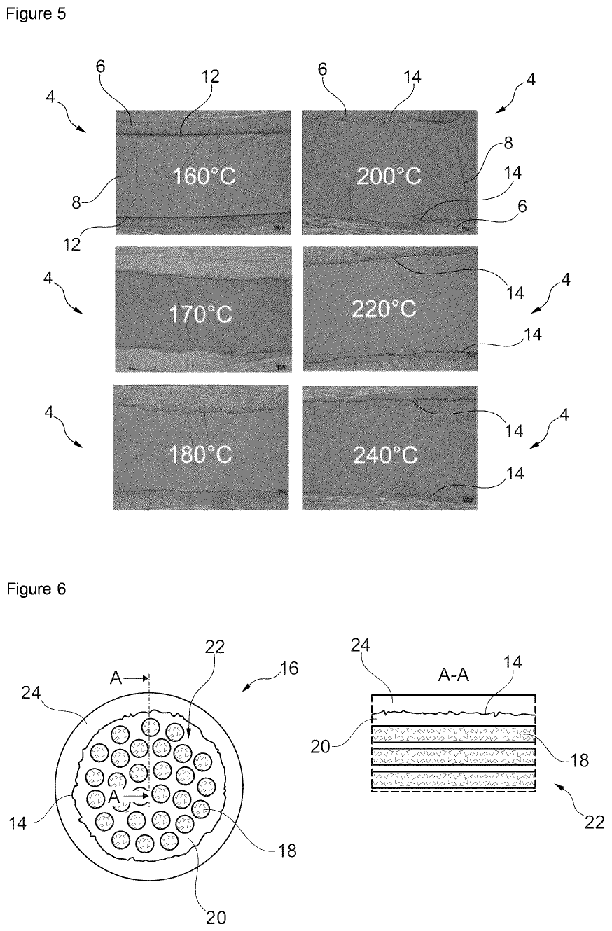

In order to effectively identify the adhesion of PA12 along with the matrix containing GMA, further flatwise tensile strength tests have been performed to the sample 4 at different temperatures ranging from 160° C. to 240° C. FIG. 5 shows multiple SEM micrographs of the sample 4 at said different temperatures.

Concurrently to the depicted micrographs, the obtained results of adhesion between the matrix containing GMA and PA12 are shown in the table 3 below, where the adhesion is shown relatively to the adhesion at 160° C.

TABLE 3

| | Adhesion | Measured |
|---|---|---|
| | temperature | adhesion |
| Matrix composition | (° C.) | (MPa) |
| Acrylic monomer MMA (Elium ® C585) + | 160 | 0 |
| 5 mol % of GMA | 170 | 10.6 |
| | 180 | 11.7 |
| | 200 | 18 |
| | 220 | 18.4 |
| | 240 | 17.8 |

As visible on FIG. 5, the sample 4 tested at 160° C. demonstrates voids 12 between the PA12 panel 8 and the matrix panels 6.

At the temperatures of 170° C. and 180° C., the adhesion is about 11 MPa over the adhesion obtained at 160° C., however the voids are still present.

A substantial improvement is visible however at 200° C. and up to 240° C.: the voids are progressively less present and a connection 14 appears, the SEM micrographs illustrate a strong mechanical bond achieved between PA12 and the matrix containing GMA. Moreover, the measured adhesion is around 18 MPa better than at 160° C. This confirms that the matrix is well compatible with PA12, and such adhesion is beneficial to the final properties of the filament of the invention, especially when used in an additive manufacturing process such as 3D printing that uses temperatures in the same range of temperature (200-240° C.).

FIG. 6 is a representation of two cross sections of the composite filament of the invention.

In reference to the left-hand side of FIG. 6, a (not to scale) cross-section of the filament 16 is illustrated according to the invention, notably, the filament 16 is preferably obtained according to the above-described method 100, and more preferably using GMA in the blended liquid matrix.

It is to note that the use of MA instead of GMA in the matrix allows to have substantially a similar filament's 16 cross-section from a physical/mechanical properties perspective.

The illustrated cross section displays several (carbon) fibers 18 forming a (continuous) thread containing a number of fibers ranging preferably from 1000 to 3000. However, the number of carbon fibers comprised in the filament 16 can be less than 1000 fibers or it can extend beyond 3000 fibers.

The fibers 18 are impregnated by the reactive matrix 20, thus forming the impregnated thread 22. The filament 16 further comprises the co-extruded sheath layer 24 wrapping the impregnated thread 22.

The cross section of FIG. 6 further displays the connection 14 formed by a portion of both the reactive matrix 20 and the sheath layer 24, the portions have been blended together forming a strong bond 14 around the fibers 18.

The filament 16 of the invention differs from a known filament of prior art, notably, through the specific materials employed in the composition of each of the reactive matrix 20 and in the sheath layer 24, and through the presence of the sheath layer 24 around such reactive matrix 20.

This connection 14 results from the fact that the reactive matrix 20 and the sheath layer 24 are in contact with each other when being both in a (semi) liquid phase. Chemical and mechanical bond ensue.

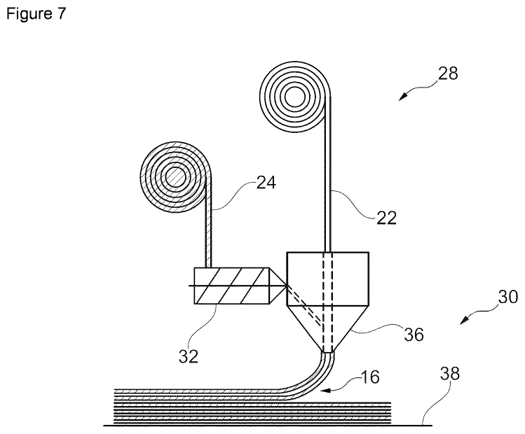

In fact, right after a FFF (which will be detailed below relatively to FIG. 7), the filament 16 is subject to cooling at room temperature, which enables the sheath layer 24 to solidify. Thus, forming a hard and resistant linking portion 14, the latter enables achieving an overall improved morphology and a better adhesion quality between the impregnated thread 22 and the polyamide sheath layer 24, which is directly beneficial to the FFF end product.

Said bond can also be well observed in the longitudinal cross section A-A of the filament 16 arranged at the right-hand side of FIG. 6.

In reference to the right-hand side of FIG. 6, the connection 14 of the filament 16 shows a mechanical bond linking the impregnated thread 22 with the sheath layer 24. In fact, the mechanical bond is particularly initiated by a prior chemical bond, which is the interaction between amine-termated, notably amino groups contained in the polyamide, with GMA or MA groups contained in the thermoplastic matrix.

The chemical reaction mainly occurs right after co-extrusion of the sheath layer 24 and before polymerization of the filament 16. The final adhesion however, is obtained during polymerization, wherein the reactive matrix fully polymerizes and a physical combination between the latter and the sheath layer 24 occurs, thus forming a strong bond capable of supporting a pull-off force of up to 19 MPa.

Advantageously, polymerization enables a great interlocking between the sheath layer 24 and the impregnated thread 22, thus forming an overall improved morphology and a better adhesion quality between the former and the latter. Thus, demonstrating the superior joining properties of the filament.

FIG. 7 is an illustration of a 3D printing process with the use of a 3D printing machine 28, commonly known as 3D printer 28, using the composite filament 16 in order to manufacture an end product 30.

The 3D printer 28 is configured to unwind a bobbin containing the impregnated thread 22 of the filament 16 of the invention. An additional bobbin provides a polymer reinforcing fiber 24, corresponding to the sheath layer material 24 which can be polyamide 6 or polyamide 12 or polyamide 66 or a mixture thereof, and preferably polyamide 12.

The 3D printer 28 can co-extrude the polymer reinforcing fiber 24 onto the impregnated thread 24 of the invention using a co-extrusion die 32. The die 32 outputs melted polyamide into the heated 3D printer nozzle 36, said co-extrusion is achieved by the channel convergence illustrated with dotted lines. Thus, a chemical compatibility occurs and a mechanical bond ensues between the polyamide of the sheath layer 24 and the impregnated thread 22.

In this configuration, the nozzle 36 outputs the filament 16 of the invention directly on the table 38, the nozzle 36 being configured to operate displacements in the three dimensions with respect to a horizontal table 38 (or alternatively the table 38 moves relatively to the nozzle 36). Therefore, forming the end product 30 on the table 38. As a result, the FFF part 30 is formed from successive layers of the melted filament 16. Advantageously, the 3D-printed part 30 demonstrates an improved material formability and an overall improved material health, i.e., micro voids and air canals are avoided.

Advantageously, the end product 30 obtained by the use of the filament 16 has improved mechanical properties and overall morphology, and an enhanced ageing resistance, enabling its use in a very physically demanding configuration, such as a structural application, or in an automotive application, transportation, or in industry in general.

1-15. (canceled)

16. A filament for an additive manufacturing application or a winding application, the filament comprising:
fibers embedded in a reactive matrix, the reactive matrix comprising:
a blend of a reactive thermoplastic matrix with a glycidyl methacrylate monomer and/or with a methacrylic acid monomer; and
a sheath layer wrapping the reactive matrix, the sheath layer being made of a thermoplastic material.

17. The filament according to claim 16, wherein the reactive thermoplastic matrix is mainly composed of (meth)acrylic polymer, (meth)acrylic monomer and organic peroxides.

18. The filament according to claim 16, wherein the reactive matrix comprises the glycidyl methacrylate monomer and/or the methacrylic acid monomer, in an amount of 0.1 to 10 wt % of the reactive matrix.

19. The filament according to claim 16, wherein the weight ratio of the glycidyl methacrylate monomer and/or the methacrylic acid monomer particles to the reactive thermoplastic matrix particles is 0.001:1 to 0.1:1.

20. The filament according to claim 16, wherein the thermoplastic material of the sheath layer comprises polyamide, the polyamide being one of:
polyamide 6,
polyamide 12,
polyamide 66, or
a mixture thereof,
said polyamide forming at least 90 wt % of the sheath layer.

21. The filament according to claim 16, wherein the reactive matrix is a co-polymer comprising poly(methyl methacrylate-co-glycidyl methacrylate).

22. The filament according to claim 16, wherein the reactive matrix is a co-polymer comprising poly(methyl methacrylate-co-methacrylic acid).

23. A use of a filament for manufacturing an end-product by an additive manufacturing process or by a winding technique, said filament comprising:
fibers embedded in a reactive matrix, the reactive matrix comprising:
a blend of a reactive thermoplastic matrix with a glycidyl methacrylate monomer and/or with a methacrylic acid monomer; and
a sheath layer wrapping the reactive matrix, the sheath layer being made of a thermoplastic material.

24. The use according to claim 23, wherein prior to a deposition of the filament to form the end-product, the reactive matrix is wrapped in by the sheath layer.

25. A product obtained by a use of a filament for manufacturing an end-product by an additive manufacturing process or by a winding technique, said filament comprising:
fibers embedded in a reactive matrix, the reactive matrix comprising:
a blend of a reactive thermoplastic matrix with a glycidyl methacrylate monomer and/or with a methacrylic acid monomer; and
a sheath layer wrapping the reactive matrix, the sheath layer being made of a thermoplastic material.

26. A method for manufacturing a filament aimed at an additive manufacturing application or a winding application, the method comprising the steps of:
providing a thread of fibers;
impregnating the thread with a reactive matrix comprising a reactive blend of: a liquid reactive thermoplastic matrix with a glycidyl methacrylate monomer and/or with a methacrylic acid monomer; and
co-extruding a sheath layer of thermoplastic material around the impregnated thread.

27. The method according to claim 26, wherein prior to impregnating the thread, the method comprises the step of:
blending the glycidyl methacrylate monomer and/or the methacrylic acid monomer in a content of 0.1 to 10 wt % of an entire amount of the matrix, with the liquid reactive thermoplastic matrix being mainly composed of (meth)acrylic polymer, (meth)acrylic monomer and organic peroxides.

28. The method according to claim 26, wherein at least 90 wt % of the thermoplastic material is made of polyamide.

29. The method according to claim 26, wherein the thermoplastic material is co-extruded at a temperature comprised in the range of 160-240° C.

30. The method according to claim 26, wherein the thermoplastic material is co-extruded at a rate of about 10 meters per minute.
